(19) United States
(12) Patent Application Publication
(10) Pub. No.: US 2025/0242874 A1
(43) Pub. Date: Jul. 31, 2025

(54) BEARING ASSEMBLY WITH PROTECTIVE FLANGED SEAL STRUCTURE FOR TRACK SYSTEM WHEELS

(71) Applicant: SOUCY INTERNATIONAL INC., Drummondville (CA)

(72) Inventor: Jeremie AUBIN-MARCHAND, Saint-Hugues (CA)

(21) Appl. No.: 19/033,976

(22) Filed: Jan. 22, 2025

Related U.S. Application Data
(60) Provisional application No. 63/625,058, filed on Jan. 25, 2024.

(51) Int. Cl. B62D 55/15; B62D 55/04; B62D 55/088

(52) U.S. Cl. CPC B62D 55/15; B62D 55/088; B62D 55/04

(57) ABSTRACT

A protective flanged seal structure for a bearing assembly of track system wheels is presented. The protective flanged seal structure incorporates an attachment surface connected to a sealed bearing housing of the track system, a sealing element configured to contact a rotary part of the track system, one or more resilient lips radially extending from the sealing element to maintain resilient contact with the rotary part during movement, and a lubricating agent sealably contained by the sealing element. The one or more radially extending resilient lips are configured with externally facing slanted profiles to shield the sealed bearing housing from exposure to debris or moisture. The protective flanged seal structure further incorporates a fluid inlet structure to facilitate insertion of the lubricating agent for replenishment.

### CROSS-REFERENCE TO RELATED APPLICATIONS

This application claims the benefit of and priority to U.S. provisional patent application No. 63/625,058, filed on Jan. 25, 2024; the content of which is herein incorporated in entirety by reference.

### FIELD OF TECHNOLOGY

The present technology generally relates to wheels for track systems and, in particular, to bearing assemblies incorporating a protective seal for track system wheels.

### BACKGROUND

Certain vehicles are specifically designed to operate in mud, snow, ice, or other challenging terrain, such as, for example, recreational vehicles, agricultural vehicles, construction vehicles, military vehicles, etc. Such vehicles can be equipped with track-based systems.

These track-based vehicles include wheel assemblies, such as, for example, drive wheel assemblies, idler wheel assemblies, and mid-roller wheel assemblies to actuate and facilitate the movement of their endless track belt during travel. These wheel assemblies typically include bearing assemblies that rotationally connect wheels to corresponding axles, thereby enabling the wheels to rotate smoothly. Such bearing assemblies are typically sealed and incorporate rotational or rolling elements that are internally lubricated to minimize friction.

However, in travelling over challenging terrain or harsh conditions, the bearing assemblies may be exposed to moisture, ice, and debris that can, over time, compromise the quality of the lubricant and durability of the bearing assemblies, which in turn can adversely affect wheel performance. It will be appreciated that servicing some conventional bearing assemblies that have been subjected to wear can be arduous and/or time consuming. For example, servicing worn conventional bearing assemblies may require to remove the track system from the vehicle, disassemble numerous parts, service/replace the bearing assemblies, and then reassemble the system.

Certain steps have been proposed that enable track-based vehicle users to perform do-it-yourself maintenance on bearing assemblies by incorporating an inlet structure that provides access into the containment of the bearing assemblies, so that new lubricants can be directly funneled into the internally sealed elements. However, in many instances, the internal lubricant is proprietary and not necessarily known by the users. So, if the new lubricant is not the same as the former and/or is incompatible with the former and/or if the bearing has not been purged completely out of the old lubricant, there is a risk of incompatibility between the old and new lubricant, which can lead to a degradation of the durability and/or the performance of the bearing. For instance, a mixture of two incompatible lubricant can result in material degradation of lubrication provided thereby, in some instances even increasing friction.

With this said, there appears to be drawbacks in the conventional arts with regard to measures that adequately protect track-based wheel bearing assemblies from external environmental conditions that adversely affect the durability of the bearing assemblies.

### SUMMARY OF TECHNOLOGY

It is an object of the present technology to ameliorate at least some of the drawbacks that exist in the conventional arts.

According to one aspect of the present technology, there is provided a rotary bearing assembly for a track system. The rotary bearing assembly includes a sealed bearing housing and a protective flanged seal structure connected to the sealed bearing housing. The sealed bearing housing includes an interior cylindrical body, an exterior cylindrical body and a bearing chamber. The interior cylindrical body is operatively connected to a first rotary part of the track system, the first rotary part being disposed concentrically about a rotational axis of the sealed bearing housing. The exterior cylindrical body circumferentially surrounds the interior cylindrical body. The bearing chamber is disposed between the interior and exterior cylindrical bodies and is configured to sealably include at least one rotatable element and a first lubricating agent. The protective flanged seal structure includes a sealing element configured to resiliently contact at least one of a second rotary part of the track system to shield the sealed bearing housing from exposure to debris or moisture, the second rotary part being disposed concentrically about a rotational axis of the sealed bearing housing, and the interior cylindrical body or the exterior cylindrical body.

In some embodiments, the interior cylindrical body has an interior side wall and the exterior cylindrical body has an exterior side wall, the protective flanged seal structure having an attachment surface on one end thereof that is circumferentially attached to one of the interior side wall or the exterior side wall.

In some embodiments, the first rotary part comprises one of a vehicle axle connector and a wheel axle and the second rotary part comprises an other of the vehicle axle connector and the wheel axle.

In some embodiments, the protective flanged seal structure is configured to provide an auxiliary chamber between the protective flanged seal member and one of the interior cylindrical body and the exterior cylindrical body.

In some embodiments, the auxiliary chamber is further configured to sealably contain a second lubricating agent.

In some embodiments, the protective flanged seal structure comprises a fluid inlet structure for facilitating insertion of the second lubricating agent into the auxiliary chamber.

In some embodiments, the fluid inlet structure is in fluid communication with the auxiliary chamber.

In some embodiments, the sealed bearing housing includes a seal for preventing mixture of the second lubricating agent disposed in the auxiliary chamber with the first lubricating agent disposed in the bearing chamber.

In some embodiments, in response to movement of the interior cylindrical body relative to the exterior cylindrical body about the rotational axis, the sealing element includes one or more resilient lips configured to maintain resilient contact with the at least one of a non-rotary part, the second rotary part, the interior cylindrical body or the exterior cylindrical body.

In some embodiments, the one or more resilient lips extend in at least one of an axial

direction and a radial direction.

In some embodiments, the one or more resilient lips extend radially, and have slanted profiles.

In some embodiments, the slanted profiles are oriented away or toward the sealed bearing housing.

In some embodiments, the one or more resilient lips include three resilient lips.

In some embodiments, the one or more resilient lips are made of an elastomeric material.

In some embodiments, the protective flange seal structure includes a flange segment.

In some embodiments, the sealing element is connected to the flange segment.

In some embodiments, the sealing element is connected to one of the interior cylindrical body and the exterior cylindrical body.

In some embodiments, the protective flanged seal structure is removable from the sealed bearing housing.

In some embodiments, the protective flanged seal structure is integral with one of the interior cylindrical body and the exterior cylindrical body of the sealed bearing housing.

In some embodiments, the sealing element is configured to maintain a seal during variation of one of an internal pressure and an external pressure of the rotary bearing assembly.

In some embodiments, the first lubricating agent is an organic oil.

In some embodiments, the at least one rotatable element is a plurality of rotatable elements.

In some embodiments, the plurality of rotatable elements includes one of a ball, a roller, a taper roller, a needle, a magnet, and a barrel.

According to another aspect of the present technology, there is provided a protective flanged seal structure including an attachment portion, an auxiliary chamber, a sealing element, and a lubricating agent. The attachment portion has a flange segment, and is connected to a sealed bearing housing of a track system. The auxiliary chamber is defined in part by the flange segment. The sealing element is disposed in the auxiliary chamber. The lubricating agent is disposed in the auxiliary chamber, and is sealed therein by the sealing element. The protective flanged seal structure is configured to shield the sealed bearing housing from exposure to debris or moisture.

In some embodiments, the attachment portion is selectively connected to the sealed bearing housing.

In some embodiments, the attachment portion is integral with the sealed bearing housing.

In some embodiments, the sealing element has at least one resilient lip.

In some embodiments, the at least one resilient lip has a slanted profile.

In some embodiments, the slanted profile is oriented toward or away from the sealed bearing housing.

In some embodiments, the protective flanged seal structure further includes a fluid inlet structure fluidly connected to the auxiliary chamber for facilitating insertion of the lubricating agent into the auxiliary chamber.

In some embodiments, the lubricating agent is an organic oil.

According to another aspect of the present technology, there is provided a track system for a vehicle. The track system includes a wheel axle, a vehicle axle connector aligned with the wheel axle about a rotational axis, a track frame, and a bearing assembly fastened to the track frame. The bearing assembly containing a sealed bearing housing and includes an interior cylindrical body, an exterior cylindrical body, a bearing chamber, and a protective flanged seal structure. The interior cylindrical body is operatively connected to one of the wheel axle or the vehicle axle connector. The exterior cylindrical body circumferentially surrounds the interior cylindrical body. The bearing chamber is disposed between the interior and exterior cylindrical bodies and is configured to retain an enclosed plurality of rotatable elements and a first lubricating agent. The protective flanged seal structure is connected to the sealed bearing housing. The protective flanged seal structure includes a sealing element configured to resiliently contact the other of the wheel axle or the vehicle axle connector to shield the sealed bearing housing from exposure to debris or moisture.

In some embodiments, the interior cylindrical body has an interior side wall and an exterior side wall and the protective flanged seal structure contains an attachment surface on one end thereof that is circumferentially attached to one of the interior side wall or the exterior side wall.

In some embodiments, the sealing element further comprises one or more resilient radially extending lips configured to maintain resilient contact with the other of the wheel axle or the vehicle axle connector during movement of the interior cylindrical body relative to the exterior cylindrical body about the rotational axis.

In some embodiments, the protective flanged seal structure further comprises a second lubricating agent sealably contained within the protective flanged seal structure.

In some embodiments, the protective flanged seal structure further includes a fluid inlet structure to facilitate insertion of the second lubricating agent into the protective flanged seal member.

In some embodiments, the fluid inlet structure is disposed on the protective flanged seal member and in fluid communication with the auxiliary chamber.

In some embodiments, the protective flanged seal member is configured to prevent mixture of the second lubricating agent with the first lubricating agent of the bearing chamber.

In some embodiments, the one or more resilient radially extending lips have externally facing slanted profiles.

In some embodiments, the one or more resilient radially extending lips include three resilient lips.

In some embodiments, the one or more resilient radially extending lips are made from an elastomeric material.

In some embodiments, the protective flanged seal structure is removable from the sealed bearing housing.

In some embodiments, the protective flanged seal structure is integral with one of the interior cylindrical body and the exterior cylindrical body of the sealed bearing housing.

In some embodiments, the sealing element is configured to maintain sealing during variation of one of an internal pressure and an external pressure of the bearing assembly.

In some embodiments, one of the first and second lubricating agents is an organic oil.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE FIGURES

For a better understanding of the present technology, as well as other aspects and further features thereof, reference is made to the following description which is to be used in conjunction with the accompanying drawings, where:

FIG. 1 illustrates a representative track-based vehicle, in accordance with the embodiments of the present technology;

FIG. 2 illustrates a representative track-based system, in accordance with the embodiments of the present technology;

FIG. 3A illustrates a side perspective view of part of the track-based system of FIG. 2;

FIG. 3B illustrates an exploded view of the part of the track-based system of FIG. 3A;

FIG. 3C depicts a closeup view of a bearing housing, in accordance with the embodiments of the present technology;

FIG. 4A illustrates a cross-sectional view of a protective flanged seal structure in accordance with the embodiments of the present technology for a bearing assembly of the track-based vehicle of FIG. 1;

FIG. 4B illustrates a close-up of the protective flanged seal structure and the bearing assembly of FIG. 4A;

FIG. 4C illustrates a close-up of the protective flanged seal structure and the bearing assembly in accordance to another embodiment of the present technology;

FIG. 4D illustrates a close-up of the protective flanged seal structure and the bearing assembly in accordance to another embodiment of the present technology;

FIG. 4E illustrates a close-up of the protective flanged seal structure and the bearing assembly in accordance to another embodiment of the present technology; and

FIG. 4F illustrates a close-up of the protective flanged seal structure and the bearing assembly in accordance to another embodiment of the present technology.

### DETAILED DESCRIPTION

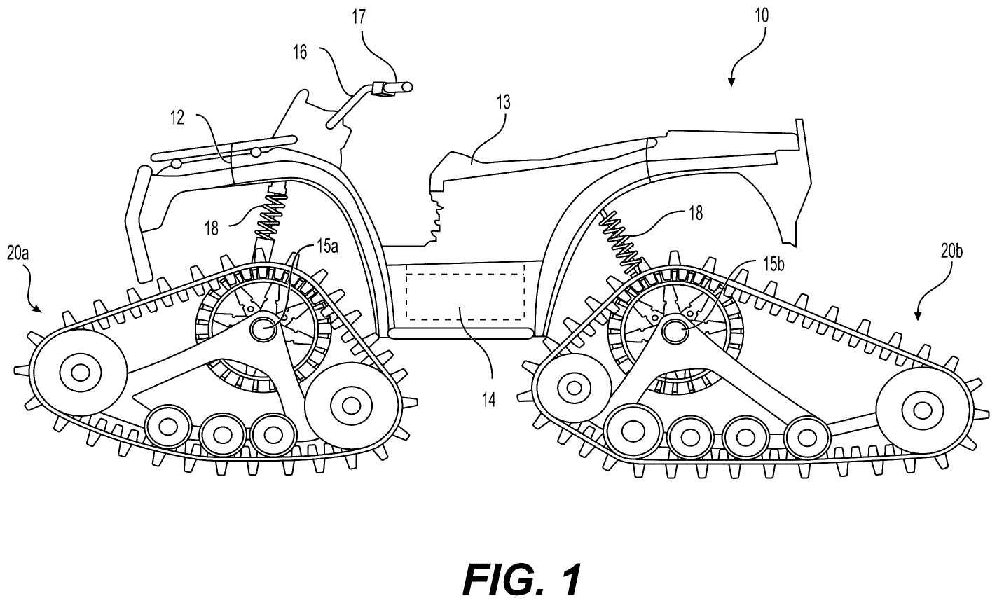

FIG. 1 illustrates a representative track-based vehicle 10, in accordance with the embodiments of the present technology. In the illustrated embodiment, the vehicle 10 is an off-road vehicle 10. More precisely, the vehicle 10 is an all-terrain vehicle (ATV) 10. It is contemplated that in other embodiments, the off-road vehicle 10 could be a snowmobile, a side-by-side vehicle (SSV), a utility-task vehicle (UTV) or another type of vehicle. The off-road vehicle 10 has four track systems in accordance with embodiments of the present technology, two front track systems 20a, and two rear track systems 20b. In some embodiments, the off-road vehicle 10 could have more or less than four track systems.

The off-road vehicle 10 includes a frame 12, a straddle seat 13 disposed on the frame 12, a powertrain 14 (shown schematically), a steering system 16, a suspension system 18, and the front and rear track systems 20a, 20b.

The powertrain 14, which is supported by the frame 12, is configured to generate power and transmit said power to the front and rear track systems 20a, 20b via driving axles, thereby driving the off-road vehicle 10. More precisely, the front track systems 20a are operatively connected to a front axle 15a and, the rear track systems 20b are operatively connected to a rear axle 15b, where the front and rear axles 15a, 15b are driven by the powertrain 14. It is contemplated that in some embodiments, the powertrain 14 could be configured to provide its motive power to only the front axle 15a or to only the rear axle 15b (i.e., in some embodiments, only one of the front axle 15a and/or rear axle 15b could be a driving axle). In some embodiments, the track systems 20a, 20b are operatively connected to non-driven axle of unpowered vehicles (e.g., trailer).

The steering system 16 is configured to enable an operator of the off-road vehicle 10 to steer the off-road vehicle 10. To this end, the steering system 16 includes a handlebar 17 that is operable by the operator to direct the off-road vehicle 10 along a desired course. In other embodiments, the handlebar 17 could be replaced by another steering device such as, for instance, a steering wheel. The steering system 16 is configured so that in response to the operator handling the handlebar 17, the orientation of the front track systems 20a is changed relative to the frame 12, thereby causing the off-road vehicle 10 to turn in a desired direction.

The suspension system 18, which is connected between the frame 12 and the track systems 20a, 20b allows relative motion between the frame 12 and the track systems 20a, 20b and can enhance handling of the off-road vehicle 10 by absorbing shocks and helping to maintain adequate traction between the track systems 20a, 20b and the ground.

The front and rear track systems 20a, 20b are configured to compensate for and/or otherwise adapt to the suspension system 18 of the off-road vehicle 10. For instance, the front and rear track systems 20a, 20b are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the off-road vehicle 10 was originally designed to use wheels instead of the front and rear track systems 20a, 20b, the alignment settings could originally have been set to optimize travel, handling, ride quality, etc. of the off-road vehicle 10 with the use of wheels. Since the track systems 20a, 20b are structurally different and behave differently from wheels, the track system 20a, 20b may be configured to compensate for and/or otherwise adapt to the alignment settings to enhance their traction and/or other aspects of their performances and/or use.

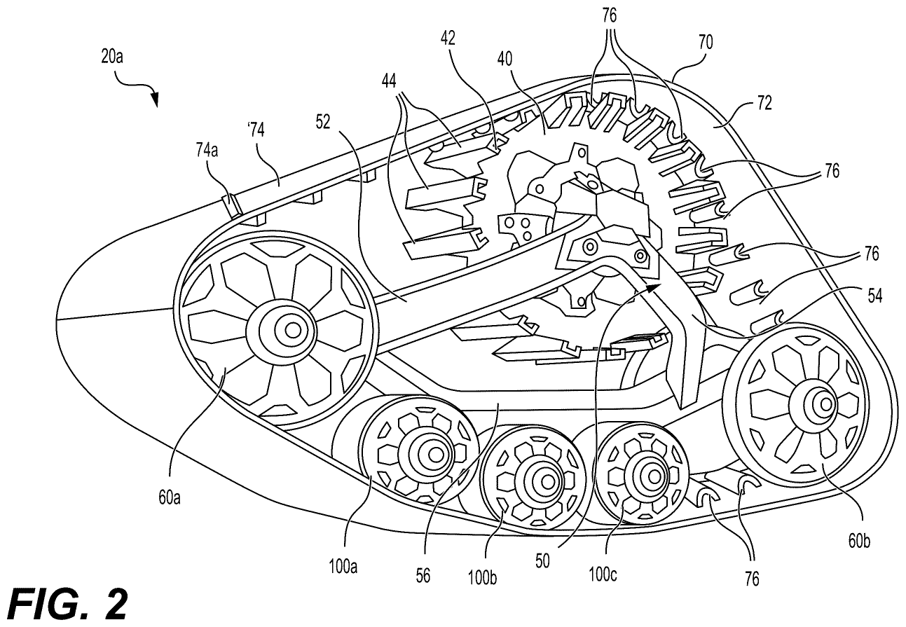

FIG. 2 illustrates a representative track-based system 20, in accordance with the embodiments of the present technology. It will be appreciated that, for the purposes of the present disclosure, the features of track-based system 20 are intended to be applicable, in whole or in part, to a variety of track-based vehicles such as, for example, ATVs, SSVs, UTVs, snowmobiles, agricultural vehicles, industrial vehicles, military vehicles, exploratory vehicles, robotics vehicles, etc. Although the representative track-based system 20 described herein is generally similar to a front track system 20a, it is understood that the track-based system 20 is also representative of a rear track system 20b as well, or of any generally equivalent track system, and is in no way limited by this similarity.

As shown, track system 20 comprises an endless track belt 70 and a drive wheel assembly 40 that engages the track belt 70 and is operatively coupled to a driving axle (not shown). The endless track belt 70 extends around the various components of track system 20 and manifests an inner surface 72 and an outer surface 74. The outer surface 74 of the endless track belt 70 incorporates a plurality of externally-protruding gripping treads 74 (only one shown) along the span of the outer surface of the belt. And, as detailed below, the inner surface 72 of endless track 70 incorporates lugs 76 that are adapted to engage with the engaging members 44 of the drive wheel assembly 40. It will be appreciated that the endless track 70 may be made of elastomeric, polymeric, or any other compounds suitable for such purposes.

The drive wheel assembly 40 is driven by the driving axle, to thereby drive and actuate the track system 20 for movement. The drive wheel assembly 40 includes a drive wheel 42 that defines laterally extending engaging members 44 (i.e., teeth) disposed on the circumference thereof. The engaging members 44 are adapted to engage with lugs 76 provided on an inner surface 72 of an endless track belt 70 of the track system 20. It is contemplated that in other embodiments, the configuration of the drive wheel assembly 40, and thus the manner in which the drive wheel assembly 40 engages the endless track 70, could differ without departing from the scope of the present technology.

The track system 20 further comprises a frame 50 that incorporates a leading frame member 52, a trailing frame member 54, and a lower frame member 56. The leading and trailing frame members 52, 54 are jointly connected around the driving axle, the joint connection being positioned laterally outwardly from the drive wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle.

In the depicted embodiment, the leading, trailing and lower frame members 52, 54, 56 are shown to be an integral unit. However, it is contemplated that in other embodiments, the leading, trailing and lower frame members 52, 54, 56 could be distinct members connected to one another. It is further contemplated that in other embodiments, the disclosed configuration of the frame 50 could differ without departing from the scope of the present technology.

With continued reference to FIG. 2, track system 20 further comprises a plurality of wheel assemblies, namely, a leading idler wheel assembly 60a, a trailing idler wheel assembly 60b, and a plurality of mid-roller wheel assemblies 100a, 100b, 100c. As noted above, the wheel assemblies are configured to properly guide and maintain alignment of the endless track belt. In some instances, the idler wheel assemblies 60a, 60b are generally configured to maintain proper tension of the endless track belt (e.g., via a tensioning system) while the mid-roller wheel assemblies 100a, 100b, 100c are generally configured to engage with the ground and maintain proper width alignment of the endless track belt relative to the direction of travel to avoid de-tracking. It is understood that in some configurations, idler wheel assemblies can be considered and act as mid-roller wheel assemblies.

In this embodiment, the track system 20 includes three mid-roller wheel assemblies, but it is contemplated that the track system 20 could include more or less than three mid-roller wheel assemblies. Each of the leading and trailing idler wheel assemblies 60a, 60b and the mid-roller wheel assemblies 100a, 100b, 100c includes two laterally spaced wheels. The two laterally spaced wheels are also referred to herein as left and right wheels. It is contemplated that in some embodiments, at least one of the leading and trailing idler wheel assemblies 60a, 60b, and the mid-roller wheel assemblies 100a, 100b, 100c could have a single wheel, or three or more laterally spaced wheels.

In the depicted embodiment, the leading idler wheel assembly 60a is at least indirectly rotationally connected to a leading end of the lower frame member 56, the trailing idler wheel assembly 60b is at least indirectly rotationally connected to a trailing end of the lower frame member 56, and the mid-roller wheel assemblies 100a, 100b, 100c are at least indirectly rotationally connected to the lower frame member 56 longitudinally between the leading and trailing idler wheel assemblies 60a, 60b. As mentioned above, in some cases, at least one of the leading and trailing idler wheel assemblies 60a, 60b can be operatively connected to a tensioning assembly (not shown) connected to the frame 50 and configured to adjust and/or maintain a tension in the endless track 70 by moving a given one or both of the leading and trailing idler wheel assemblies 60a, 60b toward or away from the frame 50. More specifically, the tensioning assembly comprises a tensioning mechanism (not shown) that biases the leading and/or trailing idler wheel assemblies 60a, 60b away from the frame 50 in order to obtain and/or maintain a predetermined tension in the endless track 70.

The leading and trailing idler wheel assemblies 60a, 60b and the leading, intermediate and trailing support wheel assemblies 100a, 100b, 100c are positioned to have particular vertical positions relative to one another. In the illustrated embodiment, the leading and trailing idler wheel assemblies 60a, 60b are disposed vertically higher than the leading, intermediate and trailing support wheel assemblies 100a, 100b, 100c. Additionally, the leading support wheel assembly 100a is disposed vertically higher than the intermediate and trailing support wheel assemblies 100b, 100c, which are generally level with one another.

As noted above, track-based vehicles employ support wheels to, inter alia, guide movement of the endless track belt 70 during travel. These support wheels include bearing assemblies that operatively couple the support wheels to a corresponding axle to enable the support wheels to rotate smoothly. Such bearing assemblies are typically scaled and incorporate rotational or rolling elements that are internally lubricated to minimize friction.

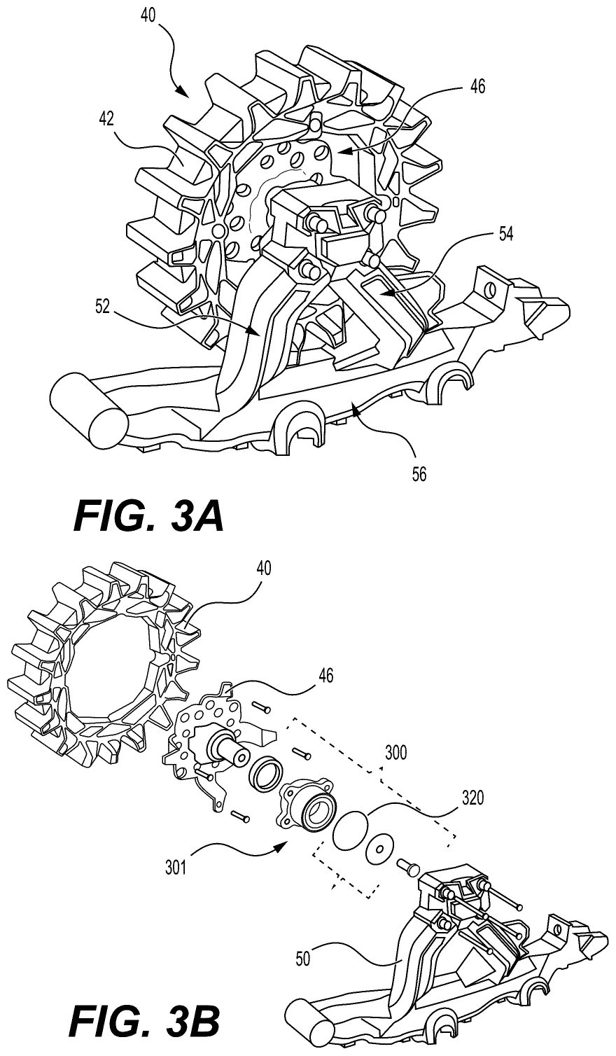

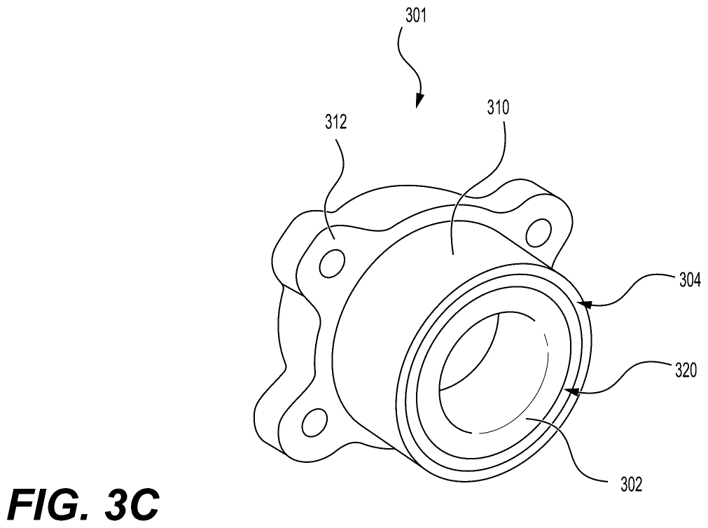

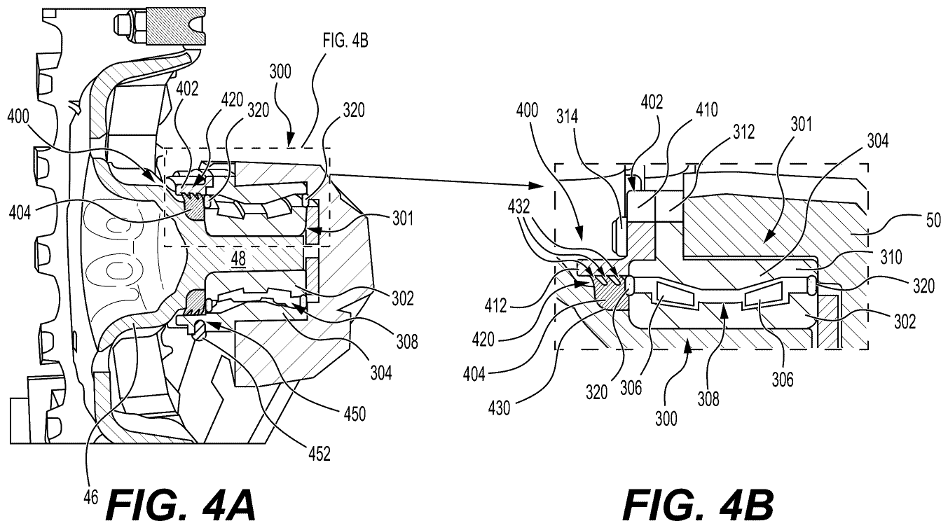

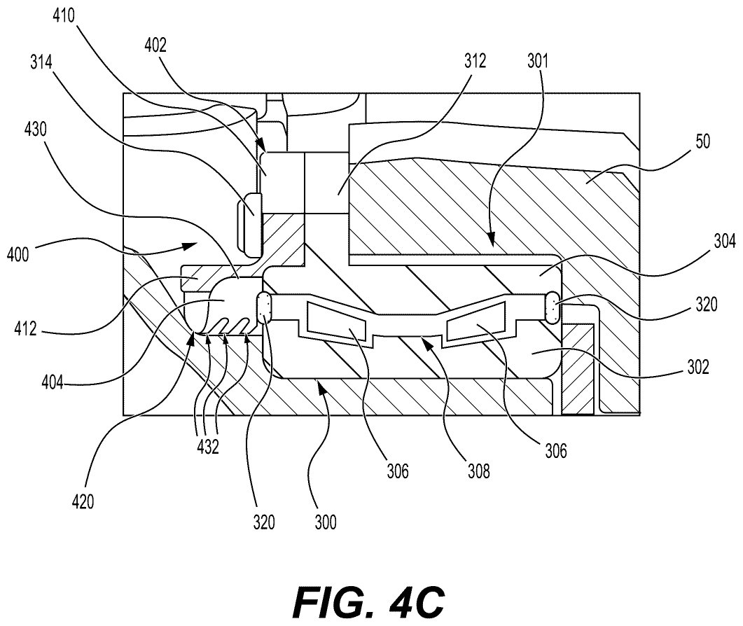

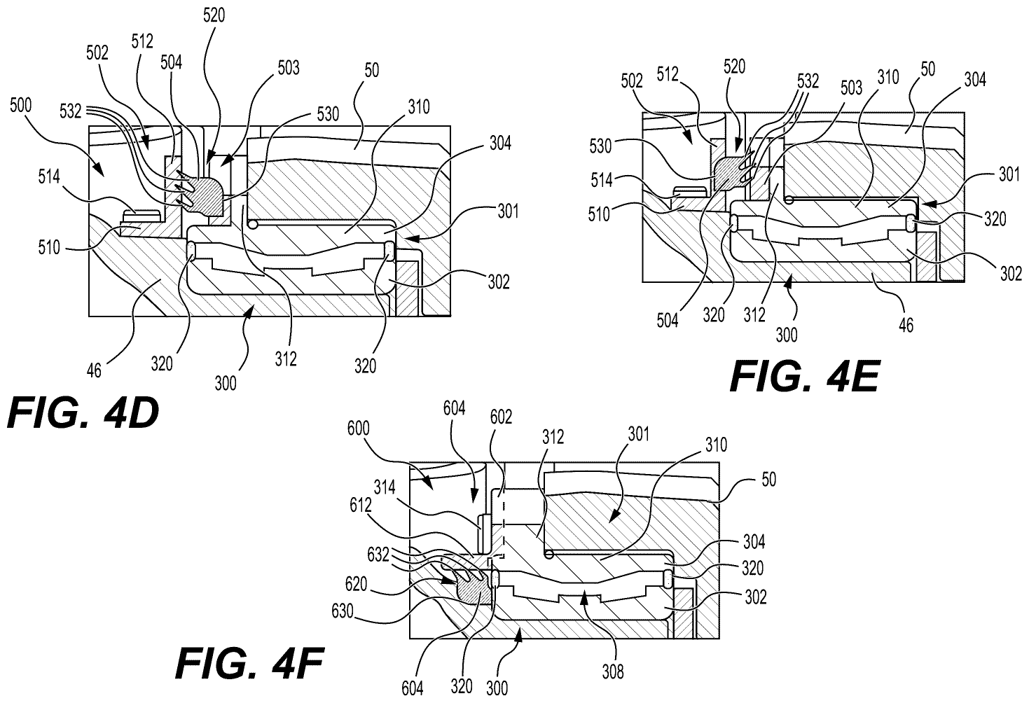

Referring to FIGS. 3A to 3C, 4A and 4B, a rotary bearing assembly 300 will now be described in greater detail with respect to the drive wheel assembly 40 and the frame 50. The rotary bearing assembly 300 rotationally connects the drive wheel assembly 40 to the frame 50. It is understood that rotary bearing assembly 300 could be implemented with the idler wheel assemblies 60a, 60b and/or with the mid-roller wheel assemblies 100a, 100b, 100c. The rotary bearing assembly 300 includes a sealed bearing housing 301 and a protective flanged seal structure 400.

In more detail, the drive wheel assembly 40 includes a spindle 46 that is operatively connected to the drive wheel 42, and that may further be operatively connected to the driving axle. In some embodiments, the spindle 46 may be connected to the drive wheel 42 via fasteners. It is contemplated that in some embodiments, the spindle 46 may be considered as being a separate component from the drive wheel assembly 40. The operative connection between the spindle 46 and the drive wheel 42 is such that they are rotationally fixed relative to one another (i.e., in response to the spindle 46 rotating, the drive wheel 42 rotates as well). The spindle 46 has an axial portion 48 that is configured to connect to the rotary bearing assembly 300. The rotary bearing assembly 300 is also connected to the frame 50, resulting in the spindle 46 being rotatable relative to the frame 50.

The sealed bearing housing 301 includes an interior body 302, an exterior body 304 circumferentially surrounding the interior body 302, rolling elements 306 (shown in FIG. 4B) disposed between the interior and exterior bodies 302, 304 as well as a first lubricating agent. The interior and exterior bodies 302, 304, which are generally cylindrical, define therebetween a bearing chamber 308. The bearing chamber 308 is configured to receive the rolling elements 306 and the first lubricating agent.

The interior body 302 is generally tubular and is configured to connect to the axial portion 48 of the spindle 46. In some embodiments, the interior body 302 could be connected to the axial portion 48 via a press-fit connection. It is contemplated that in other embodiments, the interior body 302 may be connected to another rotary part of the track system 20, such as a vehicle axle connector or a wheel axle both of which would be aligned about a rotational axis.

The exterior body 304 is configured to connect to the frame 50. In the non-limiting illustrated embodiment, the exterior body 304 has an axial segment 310 and connecting segments 312 (three shown in FIG. 3C). The connecting segments 312 are configured to receive a fastener 314 therein. Thus, the exterior body 304 can be connected to the frame 50 via the fasteners 314 and the connecting segments 312. In some embodiments, the fasteners 314 may provide a selective connection. In some embodiments, the exterior body 304 may be press-fitted into the frame 50.

It is contemplated that in some embodiments, the interior body 302 may be connected to the frame 50, and the exterior body 304 may be connected to the spindle 46.

In the illustrated embodiment, the rolling elements 306 include a plurality of left and right tapered rollers 306. It is contemplated, however, that in some embodiments, the rolling elements 306 could be provided as balls, straight rollers, needles, magnets, and/or barrels. In some embodiments, there could be a single rolling element. In other embodiments, the rolling elements 306 could be omitted altogether, and the interior and exterior bodies 302, 304 could be configured to rotate relative to one another due to low friction. For example, the interior and exterior bodies 302, 304 may be configured to have a low coefficient of friction therebetween or use one or more self-lubricating material.

The first lubricating agent is generally a high quality lubricating agent. The first lubricating agent can be an organic oil such as a petroleum based lubricant.

The sealed bearing housing 301 also includes two rings 320. Each ring 320 is disposed on one lateral side of the sealed bearing housing 301, such that the rings 320 can be said to define the lateral sides of the bearing chamber 308. The rings 320 are configured to sealingly encapsulate the rotatable elements 306 and the first lubricating agent within the bearing chamber 308. The rings 320 are also configured to assist in limiting debris from entering into the bearing chamber 308. As will be described in greater detail below, the rings 320 may be referred to as first sealing components.

As previously noted, during repeated travel over challenging terrain or harsh conditions, the sealed bearing housing 301 may become exposed to moisture, ice, debris, etc. that may compromise the quality and functionality thereof including the rolling elements 306 and the first lubricating agent. To this end, FIGS. 4A and 4B illustrate cross-sectional views of the protective flanged seal structure 400 for a bearing assembly of a track-based vehicle, in accordance with an embodiment of the present technology. The protective flanged seal structure 400 is designed to shield the sealed bearing housing 301 and respective parts therein from exposure to debris or moisture. As will be described below, the protective flanged seal structure 400 may be referred to as a second sealing component.

As generally shown in FIG. 4B, the protective flanged seal structure 400 includes an attachment portion 402 and a sealing element 404. As will be described below, the orientation and configuration of the attachment portion 402 and of the sealing element 404 may vary from one embodiment to another.

The attachment portion 402 has a connecting segment 410 and a flange segment 412. In the embodiment illustrated in FIG. 4B, the connecting segment 410 is configured to align with one of the connecting segments 312 and receive a corresponding one of the fasteners 314 therethrough. It can be said that the connecting segment 410 is circumferentially connected to the exterior body 304. Therefore, the protective seal structure 400 is configured to connect to an existing sealed bearing housing 301. That is, it may be possible to connect the protective seal structure 400 to a sealed bearing housing 301 that was not originally designed to be used with the protective seal structure 400.

In this embodiment, the attachment portion 402 is rotationally fixed to the exterior body 304. Thus, in response to the spindle 46 rotating, since the exterior body 304 does not rotate relative to the spindle 46, the protective flanged seal structure 400 also does not rotate relative to the spindle 46. As will be described below, in other embodiments, the attachment portion 402 may be connected to an other rotary part of the track system. In some instances, the rotary part may be rotatable relative to the frame 50.

The flange segment 412 extends generally parallel to the axial portion 48 of the spindle 46, away from the sealed bearing housing 301. The flange segment 412 is radially spaced from the axial portion 48. This spacing is configured to, inter alia, receive the sealing element 404 therein.

The sealing element 404, which is, inter alia, configured to shield the sealed bearing housing 301 from exposure to debris or moisture, is disposed radially between the spindle 46 and the flange segment 412. As will be described below, a position and/or orientation of the scaling element 404 may vary from one embodiment to another. The sealing element 404 can be made from an elastomeric material. In some embodiments, the sealing element 404 could be an O-ring seal or a shear seal. In the present embodiment, the sealing element 404 is a one-way seal that has a connecting surface 430, and lips 432 that are opposite to the connecting surface 430.

In the illustrated embodiment, the connecting surface 430 is configured to engage the axial portion 48 of the spindle 46 such that the connecting surface 430 is rotationally fixed to the axial portion 48. The lips 432, on the other side, are configured to engage the flange segment 412. There are three lips 432 that extend, with reference to FIG. 4B, generally radially. It is contemplated that the number of lips 432 and the orientation thereof can vary. In the illustrated embodiment, the lips 432 have slanted profiles facing away from the sealed bearing housing 301. The lips 432 can be oriented so as to facilitate assembly of the protective flanged seal structure 400. For example, the sealing element 404 can be connected to the spindle 46, and then when the flange segment 412 slides over the sealing element 404, the lips 432 are oriented in the direction opposing assembly direction (e.g., away from the sealed bearing housing 301). In other embodiments, where the assembly direction is in the opposite direction, the lips 432 could be oriented in the opposite direction. In some other instances, the sealing element 404 may be manufactured with the orientation of lips 432 in the slanted profiles.

In this embodiment, due to the connecting surface 430 being rotationally fixed to the axial portion 48, in response to the spindle 46 rotating, the sealing element 404 rotates also. The lips 432 rotate with the spindle 46 relative to the flange segment 412, while maintaining resilient contact with the flange segment 412. This can assist in optimizing shielding the sealed bearing housing 301 from external debris or moisture. Thus, in this embodiment, the attachment portion 402 is fixedly connected to a generally stationary part (with respect to the spindle 46), whereas the sealing element 404 is fixed to a rotating part (the spindle 46).

In some other embodiments, such that the one illustrated in FIG. 4C, the connecting surface 430 is configured to engage the flange segment 412 such that the connecting surface 430 is rotationally fixed to the attachment portion 402. In such embodiments, the lips 432 would be configured to engage the axial portion 48 of the spindle 46. Thus, in this embodiment, due to the connecting surface 430 being rotationally fixed to the flange segment 412, in response to the spindle 46 rotating, the sealing element 404, unlike the embodiment illustrated in FIG. 4B, does not rotate. However, the lips 432 are configured to maintain resilient contact with the axial portion 48 while the spindle 46 rotates. This can assist in optimizing shielding the sealed bearing housing 301 from external debris or moisture. Thus, in this embodiment, the attachment portion 402 and the sealing element 404 are both fixedly connected to a generally stationary part (with respect to the spindle 46).

Referring back to the embodiment shown in FIGS. 4A and 4B, the protective flanged seal structure 400 defines an auxiliary chamber 420. More specifically, the flange attachment portion 402 defines an auxiliary chamber 420. The auxiliary chamber 420 extends radially between the axial portion 48 of the spindle 46 and the flange segment 412 of the connecting segment 410, and axially between the sealed bearing housing 301 and an end of the flange segment 412 that is axially further from the sealed bearing housing 301. As will be described below, the auxiliary chamber 420 is fluidly isolated from the bearing chamber 308, notably by one of the rings 320. The auxiliary chamber 420 is configured to receive the sealing element 404.

In some embodiments, the protective flanged seal structure 400 includes a second lubricating agent. The second lubricating agent is received in the auxiliary chamber 420. More specifically, the second lubricating agent fills space in the auxiliary chamber 420 that is not occupied by the sealing element 404. Thus, some of the second lubricating agent is present between the lips 430. It will be noted that the second lubricating agent is prevented from mixing with the first lubricating agent due to the auxiliary chamber 420 being fluidly isolated from the bearing chamber 308 (due to the presence of one of the rings 320). The presence of the second lubricating agent can assist in optimizing shielding the sealed bearing housing 301 from external debris or moisture.

The protective flanged seal structure 400 also includes a fluid inlet structure 450 (best seen in FIG. 4A). The fluid inlet structure 450 is fluidly connected to the auxiliary chamber 420 and is accessible by an exterior of the protective flanged seal structure 400. The fluid inlet structure 450 is selectively closed by a sealing cap 452. The fluid inlet structure 450 provides fluid access to the auxiliary chamber 420, and is useful, notably, to refill the auxiliary chamber 420 with the second lubricating agent when required, without requiring disassembly. It will be noted that when the auxiliary chamber 420 is refilled with the second lubricating agent, due to the orientation of the lips 432, excess of the second lubricating agent may exit the auxiliary chamber 420 without significantly compromising integrity of the seal provided by the sealing element 404. It is contemplated that in some embodiments, the fluid inlet structure 450 may be omitted.

It is contemplated that a type of the second lubricating agent can vary. For example, the second lubricating agent can be a synthetic lubricant, a petroleum-based lubricant or a vegetable-based lubricant. In some embodiments, since the first and second lubricating agents do not mix because of the rings 320, the second lubricating agent can be an environmentally friendly lubricant. That said, in other embodiments, the second lubricating agent can be selected to be compatible with the first lubricating agent. That is, in case the second lubricating agent is ingested into the sealed bearing housing 301, a mixture of the first and second lubricating agents would not cause a detrimental effect to the lubricating properties thereof.

In some embodiments, the second lubricating agent is cheaper than the first lubricating agent. For example, in some embodiments, the second lubricating agent can be olive oil or canola oil. This can assist in reducing manufacturing and maintenance costs, as refilling the second lubricating agent is not as costly as refilling the first lubricating agent. Additionally, due to the presence of the second lubricating agent, the number of times the first lubricating agent has to be refilled or replaced is decreased, due to the protection provided by the protective flanged seal structure 400. Additionally, due to the presence of the second lubricating agent, a cheaper first lubricating agent can be selected, which can further assist in reducing manufacturing and maintenance costs.

With reference to FIG. 4D, an alternative embodiment of the protective flanged seal structure 400 will now be described, namely protective flanged seal structure 500. The protective flanged seal structure 500 includes an attachment portion 502, an attachment portion 503 and a scaling element 504. Features of the protective flanged seal structure 500 similar to those of the protective flanged seal structure 400 will not be re-described in detail herewith.

The attachment portion 502 has a connecting segment 510 and a flange segment 512. The connecting segment 510 extends generally axially and is configured to fixedly connect to the spindle 46 via a fastener 514. It is contemplated that in other embodiments, the attachment portion 502 could be connected to the spindle 46 differently or be integral thereto. The flange segment 512 extends generally orthogonally from the connecting segment 512 such that, with reference to FIG. 4D, the flange segment 512 extends generally radially. The connection of the attachment portion 502 and the spindle 46 is such that the attachment portion 502 rotates along with spindle 46.

The attachment portion 503 is connected to the sealed bearing housing 301. More specifically, the attachment portion 503 is connected to the exterior body 304 of the sealed bearing housing 301. It is contemplated that in some embodiments, the attachment portion 503 may be omitted and/or integrated with the sealed bearing housing 301.

The attachment portions 502, 503 are axially spaced from one another, and define, in part, an auxiliary chamber 520 therebetween.

Disposed within the auxiliary chamber 520 is the sealing element 504. The sealing element 504 has a connecting surface 530, and lips 532 that are opposite to the connecting surface 530. In the illustrated embodiment, the lips 532 extend generally axially, away from the sealed bearing housing 301.

In the illustrated embodiment, the connecting surface 530 is configured to engage the attachment portion 503 such that the connecting surface 530 is rotationally fixed thereto. The lips 532, on the other side, are configured to engage the flange segment 512.

Thus, in this embodiment, due to the connecting surface 430 being rotationally fixed to the attachment portion 503 and the attachment portion 503 being rotationally fixed to the exterior body 304 (and thus the frame 50), in response to the spindle 46 and the attachment portion 502 rotating, the sealing element 504 does not rotate relative to the spindle 46 or the attachment portion 502. However, the lips 532 are configured to maintain resilient contact with the flange segment 512 while the attachment portion 502 rotates with the spindle 46.

Thus, in this embodiment, the attachment portion 502 is fixedly connected to a rotating part (spindle 46), and the sealing element 404 is connected to a stationary part (with respect to the spindle 46).

In some other embodiments, such that the one illustrated in FIG. 4E, the connecting surface 530 is configured to engage the attachment portion 502 such that the connecting surface 530 is rotationally fixed thereto. The lips 532, on the other side, are configured to engage the attachment portion 503. The lips 530 have slanted profiles facing toward the sealed bearing housing 301.

In such embodiments, due to the connecting surface 530 being rotationally fixed to the attachment portion 502 and the attachment portion 502 being rotationally fixed to spindle 46, in response to the spindle 46 and the attachment portion 502 rotating, the sealing element 504 does not rotate relative to the spindle 46 or the attachment portion 502. However, the lips 532 are configured to maintain resilient contact with the attachment portion 503 while the sealing element 504 rotates relative thereto.

Thus, in this embodiment, the attachment portion 502 and the sealing element 504 are both connected to a rotating part (spindle 46 and the attachment portion 502).

With reference to FIG. 4F, an alternative embodiment of the protective flanged seal structures 400, 500 will now be described, namely the protective flanged structure 600. The protective flanged seal structure 600 includes an attachment portion 602 (shown in dotted lines) and a sealing element 604. Features of the protective flanged seal structure 600 similar to those of the protective flanged seal structure 400, 500 will not be re-described in detail herewith.

In this embodiment, the attachment portion 602 is integrated with the sealed bearing housing 301. That is, the sealed bearing housing 301 is designed with the protective flanged seal structure 600 integrated therewith.

More specifically, the attachment portion 602, which includes a flange segment 612, is integral with the exterior body 304 of the sealed bearing housing 301. It is contemplated that in some embodiments, the attachment portion 602 could be integral with the interior body 302. The integration of the attachment portion 602 to the sealed bearing housing 301 can assist in simplifying assembly of the protective flanged seal structure 600.

In this embodiment, like the protective flanged seal structure 400, an auxiliary chamber 620 is defined between the spindle 46 and the flange portion 612 of the attachment portion 602.

The sealing element 604 is received in the auxiliary chamber 620 along with the second lubricating agent.

Referring back to FIGS. 4A and 4B, a description of the sealed bearing housing 301 and the protective flanged seal structure 400 in operation will now be provided. It is understood that the protective flanged seal structures 500, 600 work similarly. During operation, the drive wheel 40 and the spindle 46 are caused to rotate (e.g., via the driving axle). The drive wheel 42 and the spindle 46 rotate relative to the frame 50 via the rotary bearing assembly 300.

During operation, for example when the track system 20 is partially submerged in a muddy terrain, water and/or debris can make their way toward the auxiliary chamber 420. It is understood that water and/or debris may make their way toward the auxiliary chamber 420 without the track system 20 being submerged (e.g., rolling on wet concrete). It will be noted that in this embodiment, the spindle 46 does not have a complex profile. Conventional wheel assemblies may have spindles (or another part) with a complex profile for causing water and/or debris to follow a relatively complex path in order to limit entry of water and/or debris toward their bearing. According to the present technology, however, the presence of the protective flanged seal structure 400 enables to bypass the need for a complex profile of the spindle. This can facilitate manufacturing and assembling processes, while also lowering costs.

The sealing element 404 is resiliently deformed between the spindle 46 and the flange segment 412, and therefore provides a seal that limits entry of fluid into the auxiliary chamber 420. The sealing element 404 also limits exit of fluid (e.g., second lubricating agent) out of the auxiliary chamber 420.

The second lubricating agent aims to fill any void that may be present between the sealing element 404 and the spindle 46 and between the sealing element 404 and the flange segment 412. Additionally, as mentioned above, when the spindle 46 rotates, the sealing element 404 rotates relative to the attachment portion 402. The relative movement therebetween can be facilitated due to the lubrication provided by the second lubricating agent.

The protective flanged seal structure 400 is thus a primary barrier.

In the event water and/or debris make their way into the auxiliary chamber 420, the rings 320 act as a secondary barrier, and further limit entry of the water and/or debris into the bearing chamber 308. The secondary barrier also prevents mixing of the first and second lubricating agents.

The primary and secondary barriers can assist in extending life of the first lubricating agent as well as the rolling elements 306.

When required, the second lubricating agent can be refilled via the fluid inlet structure 450. This can be done because the fluid inlet structure 450 is accessible from the exterior. As described above, if the second lubricating agent is refilled excessively (i.e., pressure in the auxiliary chamber 420 exceeding a threshold), the excess will just flow out of the auxiliary chamber 420. More specifically, the resilient nature of the lips 430 will enable them to deform to allow excess second lubricating agent to flow out thereof. The refilled lubricating agent does not mix with the first lubricating agent because of the ring 320.

In some instances, during operation, a pressure differential may be created. For example, if the rotary bearing assembly 300 is hot, and is submerged in water, a negative pressure differential may be created. This pressure differential could generally draw in some water and/or debris, but the presence of the protective flanged seal structure 400 can assist in preventing this from happening.

It will be noted that even if auxiliary chamber 420 is refilled with a third lubricating agent that, when mixed with the second lubricating agent, deteriorates the lubricating properties thereof, the damage is not as detrimental as if the lubricating properties of the first lubricating agent were to be deteriorated, because the first lubricating agent enables the interior and exterior bodies 302, 304 to rotate relative to one another regardless of what happens in the auxiliary chamber 420.

Modifications and improvements to the above-described embodiments of the present invention may become apparent to those skilled in the art. The foregoing description is intended to be exemplary rather than limiting.

What is claimed is:

1. A rotary bearing assembly for a track system, comprising:
a sealed bearing housing, including:
an interior cylindrical body operatively connected to a first rotary part of the track system, the first rotary part being disposed concentrically about a rotational axis of the sealed bearing housing;
an exterior cylindrical body circumferentially surrounding the interior cylindrical body; and
a bearing chamber disposed between the interior and exterior cylindrical bodies and configured to sealably include at least one rotatable element and a first lubricating agent; and
a protective flanged seal structure connected to the sealed bearing housing,
the protective flanged seal structure including a sealing element configured to resiliently contact at least one of:
a second rotary part of the track system to shield the sealed bearing housing from exposure to debris or moisture, the second rotary part being disposed concentrically about a rotational axis of the sealed bearing housing; and
the interior cylindrical body or the exterior cylindrical body.

2. The bearing assembly of claim 1, wherein the interior cylindrical body has an interior side wall and the exterior cylindrical body has an exterior side wall, the protective flanged seal structure having an attachment surface on one end thereof that is circumferentially attached to one of the interior side wall or the exterior side wall.

3. The bearing assembly of claim 1, wherein the first rotary part comprises one of a vehicle axle connector and a wheel axle and the second rotary part comprises an other of the vehicle axle connector and the wheel axle.

4. The bearing assembly of claim 1, wherein the protective flanged seal structure is configured to provide an auxiliary chamber between the protective flanged seal member and one of the interior cylindrical body and the exterior cylindrical body.

5. The bearing assembly of claim 4, wherein the auxiliary chamber is further configured to sealably contain a second lubricating agent.

6. The bearing assembly of claim 5, wherein the protective flanged seal structure comprises a fluid inlet structure for facilitating insertion of the second lubricating agent into the auxiliary chamber.

7. The bearing assembly of claim 6, wherein the fluid inlet structure is in fluid communication with the auxiliary chamber.

8. The bearing assembly of claim 5, wherein the sealed bearing housing includes a seal for preventing mixture of the second lubricating agent disposed in the auxiliary chamber with the first lubricating agent disposed in the bearing chamber.

9. The bearing assembly of claim 1, wherein in response to movement of the interior cylindrical body relative to the exterior cylindrical body about the rotational axis, the sealing element includes one or more resilient lips configured to maintain resilient contact with the at least one of a non-rotary part, the second rotary part, the interior cylindrical body or the exterior cylindrical body.

10. The bearing assembly of claim 9, wherein the one or more resilient lips extend in at least one of an axial direction and a radial direction.

11. The bearing assembly of claim 9, wherein the one or more resilient lips extend radially, and have slanted profiles.

12. The bearing assembly of claim 11, wherein the slanted profiles are oriented away or toward the sealed bearing housing.

13. The bearing assembly of claim 1, wherein the protective flange seal structure includes a flange segment.

14. The bearing of claim 13, wherein the sealing element is connected to the flange segment.

15. The bearing assembly of claim 1, wherein the sealing element is connected to one of the interior cylindrical body and the exterior cylindrical body.

16. The bearing assembly of claim 15, wherein the protective flanged seal structure is removable from the sealed bearing housing.

17. The bearing assembly of claim 1, wherein the protective flanged seal structure is integral with one of the interior cylindrical body and the exterior cylindrical body of the sealed bearing housing.

18. The bearing assembly of claim 1, wherein the sealing element is configured to maintain a seal during variation of one of an internal pressure and an external pressure of the rotary bearing assembly.

19. The bearing assembly of claim 1, wherein the first lubricating agent is an organic oil.

20. A protective flanged seal structure, comprising:
an attachment portion having a flange segment, the attachment portion being connected to a sealed bearing housing of a track system;
an auxiliary chamber defined in part by the flange segment;
a sealing element disposed in the auxiliary chamber;
a lubricating agent disposed in the auxiliary chamber, and being sealed therein by the sealing element,
wherein the protective flanged seal structure is configured to shield the scaled bearing housing from exposure to debris or moisture.
